(19) United States
(12) Patent Application Publication
(10) Pub. No.: US 2007/0225441 A1
(43) Pub. Date: Sep. 27, 2007

(54) Flame resistant, impact modified polycarbonate compositions

(75) Inventors: Eckhard Wenz, Koln (DE); Thomas Eckel, Dormagen (DE); Vera Buchholz, Koln (DE); Dieter Wittmann, Leverkusen (DE); Burkhard Thuermer, Bornheim (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/725,388

(22) Filed: Mar. 19, 2007

(30) Foreign Application Priority Data
Mar. 22, 2006 (DE) 102006012988.1

(51) Int. Cl. C08L 51/00

(52) U.S. Cl. 525/67

(57) ABSTRACT

A flame resistant, impact-modified polycarbonate composition is disclosed. The composition that is suitable especially for preparing thermoformed articles comprises branched aromatic polycarbonate and/or branched aromatic polyester carbonate, a graft polymer containing silicone rubber or silicone acrylate rubber, talc, and a phosphorus-containing flameproofing agent, and meets high requirements in terms of fireproofing. Also disclosed is a process for the preparation of the composition and its use in the production of molded articles.

### FIELD OF THE INVENTION

The invention is directed to thermoplastic compositions and more particularly to compositions containing polycarbonate, a graft polymer, talc and phosphorous containing flame retardant.

### BACKGROUND OF THE INVENTION

JP-A 111 997 68 describes PC/ABS blends which have been provided with flame-resistant properties by means of monomeric and oligomeric phosphoric acid esters, the flame resistance being markedly improved by addition of an inorganic filler, such as, for example, talc. The reduction in the phosphate content that is achievable thereby without altering the flame resistance is insufficient, however, to achieve the melt viscosities necessary for extrusion applications. Furthermore, the inorganic filler generally has an adverse effect on the mechanical properties, in particular the toughness, of the polymer blend.

U.S. Pat. No. 5,849,827 and WO 99/07782 describe PC/ABS molding compositions which have been provided with flame-resistant properties by means of resorcinol- or bisphenol-A-based oligophosphate, the after-burning times being markedly reduced by addition of nanoscale inorganic materials in small concentrations. However, the molding compositions described therein do not possess adequate melt stability for extrusion applications either.

WO 99/57198 describes PC/ABS molding compositions which have been provided with flame-resistant properties by means of an oligophosphate derived from resorcinol and which are distinguished by a very low content of fluoropolymer—only 0.1 wt. %—which corresponds to fluorine content of 0.076%.

Linear and branched polycarbonates having a high molecular weight (31,000 or 32,000 g/mol.) are used in the molding compositions. The rheological properties of the described molding compositions (MVR) permit processing by the extrusion process. However, the molding compositions are distinguished by their inferior ESC behavior and dimensional stability under heat, in particular when flameproofing agent is used in a sufficient amount to achieve adequate flame-resistance even with thin wall thicknesses.

US 2002/0077417 A1 discloses flame-resistant polycarbonate resin compositions of branched polycarbonate, a silicone/acrylate composite graft copolymer, oligomeric phosphoric acid esters, polytetrafluoroethylene and optionally talc. Oligomeric phosphoric acid esters of the BDP type are not disclosed.

WO 02/100948 A1 discloses thermoplastic molding compositions comprising polycarbonate (optionally branched), graft polymer, talc having a mean particle size of less than 1000 nm, and optionally oligophosphates, vinyl copolymers and anti-dripping agents. WO 01/48074 A1 discloses thermoplastic molding compositions comprising optionally branched polycarbonate, graft polymer, talc of a particular purity, and optionally oligophosphates, vinyl copolymers and anti-dripping agents.

The object of the present invention was to provide a chlorine- and bromine-free molding composition which both meets particularly high requirements in terms of flame resistance, such as the requirements of materials in American rail vehicles (Docket 90 A), and may be processed extrusion owing to its high melt stability. In particular, the molding composition according to Docket 90 A must not exhibit any burning drips in ASTM E 162 and must have a flame spread index Is of less than 35 and a low smoke density (Ds 1.5 min<100 and Ds 4 min<200) according to ASTM E 662. At the same time, the molding compositions should have a tensile modulus of at least 3500 N/mm² in order to ensure adequate mechanical strength.

It has been found, surprisingly, that the desired property profile is exhibited by compositions comprising
A) from 40 to 95 parts by weight, preferably from 60 to 85 parts by weight, particularly preferably from 65 to 78 parts by weight, of branched aromatic polycarbonate and/or branched aromatic polyester carbonate,
B) from 1 to 25 parts by weight, preferably from 2 to 9 parts by weight, particularly preferably from 4 to 8 parts by weight, very particularly preferably from 4.7 to 6.6 parts by weight, of a graft polymer comprising one or more graft bases (B.2) selected from the group of the silicone rubbers (B.2.1) and silicone acrylate rubbers (B.2.2),
C) from 9 to 18 parts by weight, preferably from 10 to 15 parts by weight, particularly preferably from 10 to 12 parts by weight, of talc,
D) from 11 to 20 parts by weight, preferably from 11 to 17 parts by weight, particularly preferably from 13 to 16 parts by weight, of phosphorus-containing flameproofing agent,
E) from 0 to 3 parts by weight, preferably from 0.01 to 1 part by weight, particularly preferably from 0.1 to 0.6 part by weight, of anti-dripping agent, and
F) from 0 to 1.5 parts by weight, preferably from 0 to 1 part by weight, of thermoplastic vinyl (co)polymer (F.1) and/or polyalkylene terephthalate (F.2), the composition is particularly preferably free of thermoplastic vinyl (co)polymers (F.1) and/or polyalkylene terephthalates (F.2),
   all part by weight data in the present application being so standardized that the sum of the parts by weight of all the components in the composition is 100.

Component A

Branched aromatic polycarbonates and/or branched aromatic polyester carbonates according to component A which are suitable according to the invention are known in the literature or may be prepared by processes which are known in the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the preparation of aromatic polyester carbonates see, for example, DE-A 3 077 934).

The preparation of aromatic poly(ester)carbonates is carried out, for example, by reacting aromatic dihydroxy compounds with carbonic acid halides, preferably phosgene, and/or with aromatic dicarboxylic acid dihalides, preferably benzenedicarboxylic acid dihalides, by the phase boundary process, optionally using chain terminators, for example monophenols, and using trifunctional or tetrafunctional phenolic branching agents, which may also contain amine functionalities as active functional groups, branching in this case occurring through amide bonds. Suitable branching agents are, for example, triphenols or tetraphenols and, preferably, also those phenolic branching agents that have at least three functional groups with reduced reactivity suitable for a condensation reaction. 1,1,1-tris-(p-hydroxyphenyl)ethane is also suitable as a branching agent.

Particular preference is given to the use of isatinbiscresol as branching agent. The branching agents are used in an amount of from 0.01 to 5 mol. %, preferably from 0.02 to 2 mol. %, especially from 0.05 to 1 mol. %, particularly preferably from 0.1 to 0.5 mol. %, based on the sum of diphenol and branching agent in the poly(ester)carbonate.

Branched polycarbonates that are suitable according to the invention may also be prepared by the known melt polymerization process by reaction of diphenolic compounds with diphenyl carbonate using branching agents and chain terminators mentioned above.

Aromatic dihydroxy compounds for the preparation of the branched aromatic polycarbonates and/or aromatic polyester carbonates are preferably those of formula (I)

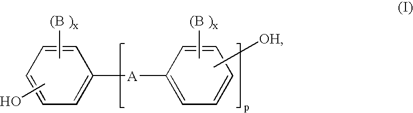

wherein
A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed other aromatic rings optionally containing hetero atoms,
or a radical of formula (II) or (III)

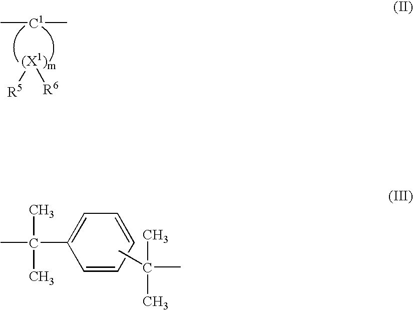

each of the substituents B represents C₁- to C₁₂-alkyl, preferably methyl, halogen, preferably chlorine and/or bromine,
the substituents x are each independently of the other 0, 1 or 2,
p represents 1 or 0, and
R⁵ and R⁶are selected individually for each X¹ and each independently of the other denotes hydrogen or C₁- to C₆-alkyl, preferably hydrogen, methyl or ethyl,
X¹ represents carbon, and
m represents an integer from 4 to 7, preferably 4 or 5, with the proviso that on at least one atom X¹, R⁵ and R⁶ are simultaneously alkyl.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl)-sulfones and α,α-bis-(hydroxyphenyl)-diisopropylbenzenes and their derivatives brominated and/or chlorinated on the ring.

Particularly preferred aromatic dihydroxy compounds are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-di-hydroxydiphenylsulfone and di- and tetra-brominated or -chlorinated derivatives thereof, such as, for example, 2,2-bis-(3-chloro-4-hydroxyphenyl)-propane, 2,2-bis-(3,5-dichloro-4-hydroxyphenyl)-propane or 2,2-bis-(3,5-dibromo-4-hydroxy-phenyl)-propane. Particular preference is given to 2,2-bis-(4-hydroxyphenyl)-propane (bisphenol A).

The aromatic dihydroxy compounds maybe used individually or in the form of any desired mixtures. The aromatic dihydroxy compounds are known in the literature or obtainable according to processes known in the literature.

Suitable chain terminators for the preparation of the thermoplastic aromatic branched polycarbonates are, for example, phenol, p-chlorophenol, p-tert-butylphenol or 2,4,6-tribromophenol, as well as long-chained alkylphenols, such as 4-(1,3-tetramethylbutyl)-phenol according to DE-A 2 842 005 or monoalkylphenols or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylheptyl)-phenol and 4-(3,5-dimethylheptyl)-phenol. The amount of chain terminators to be used is generally from 0.5 mol. % to 10 mol. %, based on the molar sum of the aromatic dihydroxy compounds used in a particular case.

In addition to the monophenols already mentioned, there come into consideration as chain terminators for the preparation of the aromatic polyester carbonates also the chlorocarbonic acid esters thereof and the acid chlorides of aromatic monocarboxylic acids, which may optionally be substituted by C₁- to C₂₂-alkyl groups or by halogen atoms, as well as aliphatic C₂- to C₂₂-monocarboxylic acid chlorides.

The amount of chain terminators is in each case from 0.1 to 10 mol. %, based in the case of phenolic chain terminators on moles of aromatic dihydroxy compounds and in the case of monocarboxylic acid chloride chain terminators on moles of dicarboxylic acid dichlorides.

The aromatic polyester carbonates may also contain aromatic hydroxycarboxylic acids incorporated therein.

The content of carbonate structural units in the thermoplastic aromatic polyester carbonates may vary as desired. The carbonate group content is preferably up to 100 mol. %, especially up to 80 mol. %, particularly preferably up to 50 mol. %, based on the sum of ester groups and carbonate groups. Both the esters and the carbonates contained in the aromatic polyester carbonates may be present in the polycondensation product in the form of blocks or in a randomly distributed manner.

The thermoplastic aromatic branched polycarbonates and polyester carbonates may be used alone or in any desired mixture. Preferred compositions according to the invention are free of linear polycarbonates and polyester carbonates.

The relative solution viscosities of the poly(ester)carbonates that are suitable according to the invention are in the range from 1.20 to 1.50, preferably from 1.24 to 1.40, especially from 1.25 to 1.35, measured in CH₂Cl₂ as solvent at 25° C. and in a concentration of 0.5 g/100 ml.

Component B

Component B comprises one or more graft polymers of
B.1 from 5 to 95 wt. %, preferably from 10 to 90 wt. %, of one or more vinyl monomers on
B.2 from 95 to 5 wt. %, preferably from 90 to 10 wt. %, of one or more graft bases selected from the group of the silicone rubbers (B.2.1) and silicone acrylate rubbers (B.2.2).

The graft copolymers B are prepared by free-radical polymerization, for example by emulsion, suspension, solution or mass polymerization, preferably by emulsion or mass polymerization.

Suitable monomers B.1 are vinyl monomers such as vinyl aromatic compounds and/or vinyl aromatic compounds substituted on the ring (such as styrene, α-methylstyrene, p-methylstyrene, p-chlorostyrene), methacrylic acid (C₁-C₈)-alkyl esters (such as methyl methacrylate, ethyl methacrylate, 2-ethylhexyl methacrylate, allyl methacrylate), acrylic acid (C₁-C₈)-alkyl esters (such as methyl acrylate, ethyl acrylate, n-butyl acrylate, tert-butyl acrylate), organic acids (such as acrylic acid, methacrylic acid) and/or vinyl cyanides (such as acrylonitrile and methacrylonitrile) and/or derivatives (such as anhydrides and imides) of unsaturated carboxylic acids (for example maleic anhydride and N-phenyl-maleimide). These vinyl monomers may be used alone or in mixtures of at least two monomers.

Preferred monomers B.1 are selected from at least one of the monomers styrene, α-methylstyrene, methyl methacrylate, n-butyl acrylate and acrylonitrile. Particular preference is given to the use of methyl methacrylate as the monomer B.1.

The glass transition temperature of the graft base B.2 is <10° C., preferably <0° C., particularly preferably <−20° C. The graft base B.2 generally has a mean particle size (d₅₀ value) of from 0.05 to 10 μm, preferably from 0.06 to 5 μm, particularly preferably from 0.08 to 1 μm.

The mean particle size d₅₀ is the diameter above and below which in each case 50 wt. % of the particles lie. It may be determined by means of ultracentrifuge measurement (W. Scholtan, H. Lange, Kolloid, Z. und Z. Polymere 250 (1972), 782-1796).

Suitable silicone rubbers according to B.2.1 are silicone rubbers having graft-active sites, the preparation method of which is described, for example, in U.S. Pat. No. 2,891,920, U.S. Pat. No. 3,294,725, DE-OS 3 631 540, EP 249964, EP 430134 and U.S. Pat. No. 4,888,388.

The silicone rubber according to B.2.1 is preferably prepared by emulsion polymerization, in which siloxane monomeric structural units, crosslinking or branching agents (IV) and optionally grafting agents (V) are used.

The siloxane monomeric structural units used are, for example and preferably, dimethylsiloxane or cyclic organosiloxanes having at least 3 ring members, preferably from 3 to 6 ring members, such as, for example and preferably, hexamethylcyclotrisiloxane, octamethylcyclotetrasiloxane, decamethylcyclopenta-siloxane, dodecamethylcyclohexasiloxane, trimethyl-triphenyl-cyclotrisiloxane, tetramethyl-tetraphenyl-cyclotetrasiloxane, octaphenylcyclotetrasiloxane.

The organosiloxane monomers may be used alone or in the form of mixtures having 2 or more monomers. The silicone rubber preferably contains not less than 50 wt. % and particularly preferably not less than 60 wt. % organosiloxane, based on the total weight of the silicone rubber component.

As crosslinking or branching agents (IV) there are preferably used silane-based crosslinking agents having a functionality of 3 or 4, particularly preferably 4. Preferred examples which may be mentioned include: trimethoxymethylsilane, triethoxyphenylsilane, tetramethoxysilane, tetraethoxysilane, tetra-n-propoxysilane and tetrabutoxysilane. The crosslinking agent may be used alone or in a mixture of two or more crosslinking agents. Tetraethoxysilane is particularly preferred.

The crosslinking agent is used in an amount in the range from 0.1 to 40 wt. %, based on the total weight of the silicone rubber component. The amount of crosslinking agent is so chosen that the degree of swelling of the silicone rubber, measured in toluene, is from 3 to 30, preferably from 3 to 25 and particularly preferably from 3 to 15. The degree of swelling is defined as the weight ratio of the amount of toluene absorbed by the silicone rubber when it is saturated with toluene at 25° C., and the amount of silicone rubber in the dry state. The determination of the degree of swelling is described in detail in EP 249964.

When the degree of swelling is less than 3, that is to say when the content of crosslinking agent is too high, the silicone rubber does not exhibit adequate rubber elasticity. When the swelling index is greater than 30, the silicone rubber is unable to form a domain structure in the matrix polymer and therefore cannot improve impact strength; the effect would then be similar to the simple addition of polydimethylsiloxane.

Tetrafunctional crosslinking agents are preferred to trifunctional crosslinking agents because the degree of swelling is then simpler to control within the above-described limits.

Suitable grafting agents (V) are compounds that are capable of forming structures having the following formula:

CH₂═C(R²)—COO—(CH₂)ₚ—SiR¹ₙO_{(3-n)/2} (V-1)

CH₂═CH—SiR¹ₙO_{(3-n)/2} (V-2) or

HS—(CH₂)ₚ—SiR¹ₙO_{(3-n)/2} (V-3),

wherein

R¹ represents C₁-C₄-alkyl, preferably methyl, ethyl or propyl, or phenyl,

R² represents hydrogen or methyl,

n represents 0, 1 or 2 and

p represents a number from 1 to 6.

Acryloyl- or methacryloyl-oxysilanes are particularly suitable for forming the above-mentioned structure (V-1), and they have high grafting efficiency. As a result, effective formation of the graft chains is ensured, and accordingly the impact strength of the resulting resin composition is favourably influenced.

Preferred examples which may be mentioned include: β-methacryloyloxy-ethyldimethoxymethyl-silane, γ-methacryloyloxy-propylmethoxydimethyl-silane, γ-methacryloyloxy-propyldimethoxymethyl-silane, γ-methacryloyloxy-propyl-trimethoxy-silane, γ-methacryloyloxy-propylethoxydiethyl-silane, γ-methacryloyloxy-propyldiethoxymethyl-silane, δ-methacryloyl-oxy-butyldiethoxymethyl-silane or mixtures thereof.

From 0 to 20 wt. % of grafting agent are preferably used, based on the total weight of the silicone rubber.

The silicone rubber may be prepared by emulsion polymerization, as described, for example, in U.S. Pat. No. 2,891,920 and U.S. Pat. No. 3,294,725. The silicone rubber is thereby obtained in the form of an aqueous latex. To that end, a mixture containing organosiloxane, crosslinking agent and optionally grafting agent is mixed with water, under shear, for example by means of a homogeniser, in the presence of an emulsifier based on sulfonic acid, such as, for example, alkylbenzenesulfonic acid or alkylsulfonic acid, the mixture polymerizing to form the silicone rubber latex. An alkylbenzenesulfonic acid is particularly suitable because it acts not only as emulsifier but also as polymerization initiator. In this case, a combination of the sulfonic acid with a metal salt of an alkylbenzenesulfonic acid or with a metal salt of an alkylsulfonic acid is advantageous because the polymer is stabilised thereby during the subsequent graft polymerization.

After the polymerization, the reaction is terminated by neutralising the reaction mixture by addition of an aqueous alkaline solution, for example by addition of an aqueous sodium hydroxide, potassium hydroxide or sodium carbonate solution.

According to the invention, silicone acrylate rubbers (B.2.2) are also suitable as graft bases B.2. These silicone acrylate rubbers are composite rubbers having graft-active sites and containing from 10 to 90 wt. % silicone rubber component and from 90 to 10 wt. % polyalkyl (meth)acrylate rubber component, the two mentioned rubber components in the composite rubber interpenetrating so that they cannot substantially be separated from one another.

If the amount of silicone rubber component in the composite rubber is too high, the finished resin compositions have disadvantageous surface properties and an impaired colouring capacity. If, on the other hand, the content of polyalkyl (meth)acrylate rubber component in the composite rubber is too high, the impact strength of the finished resin composition is adversely affected.

Silicone acrylate rubbers are known and are described, for example, in U.S. Pat. No. 5,807,914, EP 430134 and U.S. Pat. No. 4,888,388.

Suitable silicone rubber components therefor are those as already described under B.2.1.

Suitable polyalkyl (meth)acrylate rubber components of the silicone acrylate rubbers according to B.2.2 may be prepared from methacrylic acid alkyl esters and/or acrylic acid alkyl esters, a crosslinking agent (VI) and a grafting agent (VII). Examples of preferred methacrylic acid alkyl esters and/or acrylic acid alkyl esters are the C₁- to C₈-alkyl esters, for example methyl, ethyl, n-butyl, tert-butyl, n-propyl, n-hexyl, n-octyl, n-lauryl and 2-ethylhexyl esters; haloalkyl esters, preferably halo-C₁-C₈-alkyl esters, such as chloroethyl acrylate, as well as mixtures of these monomers. N-butyl acrylate is particularly preferred.

As crosslinking agents (VI) for the polyalkyl (meth)acrylate rubber component of the silicone acrylate rubber there may be used monomers having more than one polymerizable double bond. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, propylene glycol dimethacrylate, 1,3-butylene glycol dimethacrylate and 1,4-butylene glycol dimethacrylate. The crosslinking agents may be used alone or in mixtures of at least two crosslinking agents.

Examples of preferred grafting agents (VII) are allyl methacrylate, triallyl cyanurate, triallyl isocyanurate or mixtures thereof. Allyl methacrylate may also be used as crosslinking agent (VI). The grafting agents may be used alone or in mixtures of at least two grafting agents.

The amount of crosslinking agent (VI) and grafting agent (VII) is from 0.1 to 20 wt. %, based on the total weight of the polyalkyl (meth)acrylate rubber component of the silicone acrylate rubber.

The silicone acrylate rubber is produced by first preparing the silicone rubber according to B.2.1 as an aqueous latex. The latex is subsequently enriched with the methacrylic acid alkyl esters and/or acrylic acid alkyl esters that are to be used, the crosslinking agent (VI) and the grafting agent (VII), and polymerization is carried out. Preference is given to emulsion polymerization initiated by free radicals, for example by a peroxide, azo or redox initiator. Particular preference is given to the use of a redox initiator system, in particular a sulfoxylate initiator system prepared by combining iron sulfate, disodium ethylenediamine tetraacetate, rongalite and hydroperoxide.

The grafting agent (V) used in the preparation of the silicone rubber has the effect that the polyalkyl (meth)acrylate rubber component is bonded covalently to the silicone rubber component. In the polymerization, the two rubber components interpenetrate and thus form the composite rubber, which after the polymerization may no longer be separated into its constituents of silicone rubber component and polyalkyl (meth)acrylate rubber component.

For the preparation of the silicone (acrylate) graft rubbers B mentioned as component B), the monomers B.1 are grafted onto the rubber base B.2.

The polymerization methods described, for example, in EP 249964, EP 430134 and U.S. Pat. No. 4,888,388 may be used for that purpose.

The graft polymerization is carried out, for example, according to the following polymerization method: In a single- or multi-step emulsion polymerization initiated by free radicals, the desired vinyl monomers B.1 are polymerized onto the graft base, which is in the form of an aqueous latex. The grafting efficiency should be as high as possible and is preferably greater than or equal to 10%. The grafting efficiency is substantially dependent on the grafting agent (V) or (VII) used. After polymerization to the silicone (acrylate) graft rubber, the aqueous latex is added to hot water in which metal salts have previously been dissolved, such as, for example, calcium chloride or magnesium sulfate. The silicone (acrylate) graft rubber thereby coagulates and may then be separated off.

The methacrylic acid alkyl ester and acrylic acid alkyl ester graft rubbers mentioned as component B) are commercially available. Examples which may be mentioned include: Metablen® SX 005 and Metablen® SRK 200 from Mitsubishi Rayon Co. Ltd.

Component C

Talc is understood as being a naturally occurring or a synthetically prepared talc.

Pure talc has the chemical composition 3 MgO₄.SiO₂.H₂O and accordingly has an MgO content of 31.9 wt. %, an SiO₂ content of 63.4 wt. % and a content of chemically bonded water of 4.8 wt. %. It is a silicate having a layered structure.

Naturally occurring talc materials generally do not have the ideal composition mentioned above, since they are rendered impure by the partial replacement of the magnesium by other elements, by the partial replacement of silicon by, for example, aluminium, and/or by intergrowths with other minerals such as, for example, dolomite, magnesite and chlorite.

The particular types of talc within the scope of the invention are distinguished by a particularly high purity, characterised by a MgO content of from 28 to 35 wt. %, preferably from 30 to 33 wt. %, particularly preferably from 30.5 to 32 wt. %, and a SiO₂ content of from 55 to 65 wt. %, preferably from 58 to 64 wt. %, particularly preferably from 60 to 62.5 wt. %. Preferred types of talc are further distinguished by an Al₂O₃ content of less than 5 wt. %, particularly preferably less than 1 wt. %, especially less than 0.7 wt. %.

A commercially available type of talc which corresponds to this definition is, for example, Luzenac® A3 from Luzenac Naintsch Mineralwerke GmbH (Graz, Austria).

The use of the talc according to the invention in the form of finely ground types having a mean particle size d₅₀ of from 0.1 to 20 μm, preferably from 0.2 to 10 μm, particularly preferably from 1.1 to 5 μm, very particularly preferably from 1.15 to 2.5 μm, is particularly advantageous.

The talc maybe surface-treated, for example silanized, in order to ensure better compatibility with the polymer. In view of the processing and preparation of the molding compositions, the use of compacted talc is also advantageous.

Component D

Phosphorus-containing flameproofing agents (D) within the scope of the invention are preferably selected from the groups of the monomeric and oligomeric phosphoric and phosphonic acid esters, phosphonate amines and phosphazenes, it being possible to use as flameproofing agents also mixtures of several components selected from one or various of these groups. Other halogen-free phosphorus compounds not mentioned specifically here may also be used alone or in any desired combination with other halogen-free phosphorus compounds.

Preferred monomeric and oligomeric phosphoric and phosphonic acid esters are phosphorus compounds of the general formula (VIII)

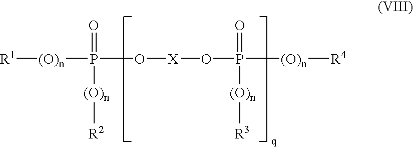

wherein
R¹, R², R³ and R⁴ independently one of the others denote C₁- to C₈-alkyl, or C₅- to C₆-cycloalkyl, C₆- to C₂₀-aryl or C₇- to C₁₂-aralkyl each optionally substituted by alkyl, preferably C₁-C₄-alkyl, and/or by halogen, preferably chlorine, bromine,
n independently of one another denote 0 or 1,
q represents 0 to 30, and
X represents a mono- or poly-nuclear aromatic radical having 6 to 30 carbon atoms, or a linear or branched aliphatic radical having 2 to 30 carbon atoms which may be OH-substituted and contain up to 8 ether bonds.

R¹, R², R³ and R⁴ independently one of the others preferably denote C₁- to C₄-alkyl, phenyl, naphthyl or phenyl-C₁-C₄-alkyl. The aromatic groups R¹, R², R³ and R⁴ may in be substituted by halogen and/or alkyl groups, preferably chlorine, bromine and/or C₁- to C₄-alkyl. Particularly preferred aryl radicals are cresyl, phenyl, xylenyl, propylphenyl or butylphenyl and the corresponding brominated and chlorinated derivatives thereof.
X in formula (VIII) preferably represents a mono- or poly-nuclear aromatic radical having from 6 to 30 carbon atoms. It is preferably derived from aromatic dihydroxy compounds of formula (I).
Each of the substituents n in formula (VIII), independently of the others, may be 0 or 1; n is preferably 1.
q represents values from 0 to 30, preferably from 0.3 to 20, particularly preferably from 0.5 to 10, especially from 0.5 to 6, very particularly preferably from 1.1 to 1.6.
X particularly preferably represents

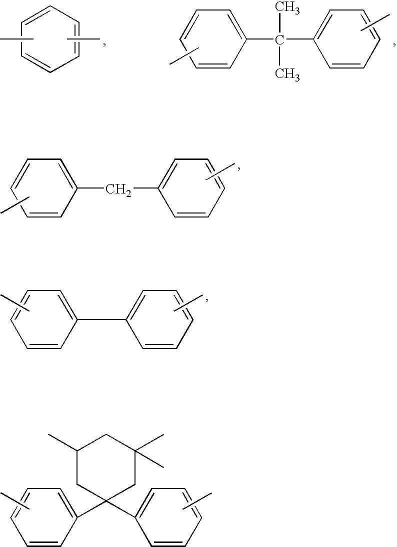

or their chlorinated or brominated derivatives; X is derived in particular from resorcinol, hydroquinone, bisphenol A or diphenylphenol. X is particularly preferably derived from bisphenol A.

It is also possible to use mixtures of different phosphates as component D according to the invention.

Phosphorus compounds of formula (VIII) are in particular tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, resorcinol-bridged diphosphate and bisphenol-A-bridged diphosphate. The use of oligomeric phosphoric acid esters of formula (VIII) derived from bisphenol A is particularly preferred.

The phosphorus compounds according to component D are known (see, for example, U.S. Pat. Nos. 5,204,394 and 5,672,645 both incorporated herein by reference) or may be prepared by known methods in an analogous manner (for example Ullmanns Encyklopädie der technischen Chemie, Vol. 18, p. 301 ff 1979; Houben-Weyl, Methoden der organischen Chemie, Vol. 12/1, p. 43; Beilstein Vol. 6, p. 177).

The mean q values may be determined by measuring the molecular weight distribution of the composition of the phosphate by a suitable method (gas chromatography (GC), high pressure liquid chromatography (HPLC), gel permeation chromatography (GPC)) and calculating the mean values of q therefrom.

It is also possible to use as flameproofing agents phosphonate amines and phosphazenes, as described in WO 00/00541 and U.S. Pat. No. 6,528,561 incorporated by reference herein.

The flameproofing agents may be used alone or in any desired mixture with one another or in admixture with other flameproofing agents.

Anti-Dripping Agents E

The compositions according to the invention may contain as anti-dripping agents preferably fluorinated polyolefins. Fluorinated polyolefins are known (see, for example, U.S. Pat. No. 5,672,645 incorporated herein by reference). A commercially available product is, for example, Teflon® 30 N from DuPont.

The fluorinated polyolefins may also be used in the form of a coagulated mixture of emulsions of the fluorinated polyolefins with emulsions of the graft polymers B) or with an emulsion of a copolymer F.1) based preferably on styrene/acrylonitrile, the fluorinated polyolefin in the form of an emulsion being mixed with an emulsion of the graft polymer or copolymer and subsequently coagulated.

The fluorinated polyolefins may also be used in the form of a pre-compound with the graft polymer B) or with a copolymer F.1) based preferably on styrene/acrylonitrile. The fluorinated polyolefins are mixed in the form of a powder with a powder or granules of the graft polymer or copolymer and are compounded in the melt generally at temperatures of from 200 to 330° C. in conventional apparatuses such as kneaders, extruders or twin-shaft screws.

The fluorinated polyolefins may also be used in the form of a masterbatch which is prepared by emulsion polymerization of at least one monoethylenically unsaturated monomer in the presence of an aqueous dispersion of the fluorinated polyolefin. Preferred monomer components are styrene, acrylonitrile and mixtures thereof. The polymer is used in the form of a pourable powder after acid precipitation and subsequent drying.

The coagulates, pre-compounds and masterbatches usually have solids contents of fluorinated polyolefin of from 5 to 95 wt. %, preferably from 7 to 60 wt. %.

Component F

Component F comprises one or more thermoplastic vinyl (co)polymers F.1 and/or polyalkylene terephthalates F.2.

Suitable vinyl (co)polymers F.1 are polymers of at least one monomer from the group of the vinyl aromatic compounds, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. Particularly suitable are (co)polymers of
F.1.1 from 50 to 99 parts by weight, preferably from 60 to 80 parts by weight, of vinyl aromatic compounds and/or vinyl aromatic compounds substituted on the ring, such as styrene, α-methylstyrene, p-methylstyrene, p-chlorostyrene, and/or methacrylic acid (C₁-C₈)-alkyl esters, such as methyl methacrylate, ethyl methacrylate, and
F.1.2 from 1 to 50 parts by weight, preferably from 20 to 40 parts by weight, of vinyl cyanides (unsaturated nitriles), such as acrylonitrile and methacrylonitrile, and/or (meth)acrylic acid (C₁-C₈)-alkyl esters, such as methyl methacrylate, n-butyl acrylate, tert-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers F.1 are resin-like, thermoplastic and rubber-free. Particular preference is given to the copolymer of F.1.1 styrene and F.1.2 acrylonitrile.

The (co)polymers according to F.1 are known and may be prepared by free-radical polymerization, in particular by emulsion, suspension, solution or mass polymerization. The (co)polymers preferably have molecular weights M_{w} (weight-average, determined by light scattering or sedimentation) of from 15,000 to 200,000.

The polyalkylene terephthalates of component F.2 are reaction products of aromatic dicarboxylic acids or reactive derivatives thereof, such as dimethyl esters or anhydrides, and aliphatic, cycloaliphatic or araliphatic diols, and mixtures of these reaction products.

Preferred polyalkylene terephthalates contain at least 80 wt. %, preferably at least 90 wt. %, based on the dicarboxylic acid component, of terephthalic acid radicals and at least 80 wt. %, preferably at least 90 mol. %, based on the diol component, of ethylene glycol and/or 1,4-butanediol radicals.

The preferred polyalkylene terephthalates may contain, in addition to terephthalic acid radicals, up to 20 mol. %, preferably up to 10 mol. %, of radicals of other aromatic or cycloaliphatic dicarboxylic acids having from 8 to 14 carbon atoms or of aliphatic dicarboxylic acids having from 4 to 12 carbon atoms, such as, for example, radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene glycol or 1,4-butanediol radicals, up to 20 mol. %, preferably up to 10 mol. %, of other aliphatic diols having from 3 to 12 carbon atoms or of cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, 1,4-cyclohexanedimethanol, 3-ethyl-2,4-pentanediol, 2-methyl-2,4-pentanediol, 2,2,4-trimethyl-1,3-pentanediol, 2-ethyl- 1,3 -hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxy-phenyl)-propane and 2,2-bis-(4-hydroxypropoxyphenyl)-propane (DE-A 2 407 674, 2 407 776, 2 715 932).

The polyalkylene terephthalates may be branched by the incorporation of relatively small amounts of tri- or tetra-hydric alcohols or of tri- or tetra-basic carboxylic acids, for example according to DE-A 1 900 270 and U.S. Pat. No. 3,692,744. Examples of preferred branching agents are trimesic acid, trimellitic acid, trimethylol-ethane and -propane and pentaerythritol.

Particular preference is given to polyalkylene terephthalates that have been prepared solely from terephthalic acid and reactive derivatives thereof (e.g. dialkyl esters thereof) and ethylene glycol and/or 1,4-butanediol, and mixtures of these polyalkylene terephthalates.

Mixtures of polyalkylene terephthalates contain from 1 to 50 wt. %, preferably from 1 to 30 wt. %, polyethylene terephthalate and from 50 to 99 wt. %, preferably from 70 to 99 wt. %, polybutylene terephthalate.

The polyalkylene terephthalates that are preferably used generally have an intrinsic viscosity of from 0.4 to 1.5 dl/g, preferably from 0.5 to 1.2 dl/g, measured in phenol/o-dichlorobenzene (1:1 parts by weight) at 25° C. in a Ubbelohde viscometer.

The polyalkylene terephthalates may be prepared according to known methods (see, for example, Kunststoff-Handbuch, Volume VIII, p. 695 ff, Carl-Hanser-Verlag, Munich 1973).

Further Additives G

The molding compositions according to the invention may further include at least one conventional additive, such as, for example, lubricants and mold release agents, nucleating agents, antistatics, stabilisers, colorings and pigments, as well as fillers and reinforcing agents other than talc.

Component G also refers to very finely divided inorganic compounds which are distinguished by an average particle diameter of less than or equal to 200 nm, preferably less than or equal to 150 nm, especially from 1 to 100 nm.

Suitable very finely divided inorganic compounds preferably include at least one polar compound of one or more metals of main groups 1 to 5 or of sub-groups 1 to 8 of the periodic system, preferably of main groups 2 to 5 or sub-groups 4 to 8, particularly preferably of main groups 3 to 5 or sub-groups 4 to 8, or of compounds of those metals with at least one element selected from oxygen, hydrogen, sulfur, phosphorus, boron, carbon, nitrogen or silicon. Preferred compounds are, for example, oxides, hydroxides, water-containing oxides, sulfates, sulfites, sulfides, carbonates, carbides, nitrates, nitrites, nitrides, borates, silicates, phosphates, hydrides, phosphites or phosphonates.

The very finely divided inorganic compounds are preferably oxides, phosphates, hydroxides, preferably of TiO₂, SiO₂, SnO₂, ZnO, ZnS, boehmite, ZrO₂, Al₂O₃, aluminium phosphates, iron oxides, also TiN, WC, AlO(OH), Fe₂O₃ iron oxides, NaSO₄, vanadium oxides, zinc borate, silicates such as Al silicates, Mg silicates, one-, two- and three-dimensional silicates. Mixtures and doped compounds may likewise be used. These very finely divided inorganic compounds may be surface-modified with organic molecules in order to achieve better compatibility with the polymers. Hydrophobic or hydrophilic surfaces may be produced in this manner.

Particular preference is given to hydrate-containing aluminium oxides (e.g. boehmite) or TiO₂.

Particle size and particle diameter refer to mean particle diameter d₅₀, determined by ultracentrifuge measurements according to W. Scholtan et al., Kolloid-Z. und Z. Polymere 250 (1972), p. 782-796.

The inorganic compounds may be in the form of powders, pastes, sols, dispersions or suspensions. Powders may be obtained from dispersions, sols or suspensions by precipitation.

The inorganic compounds may be incorporated into the thermoplastic molding compositions according to conventional processes, for example by the direct kneading or extrusion of molding compositions and the very finely divided inorganic compounds. Preferred processes are the preparation of a masterbatch, for example in flameproofing additives and at least one component of the molding compositions according to the invention in monomers or solvents, or the co-precipitation of a thermoplastic component and the very finely divided inorganic compounds, for example by the co-precipitation of an aqueous emulsion and the very finely divided inorganic compounds, optionally in the form of dispersions, suspensions, pastes or sols of the very finely divided inorganic materials.

The compositions are prepared by mixing the respective constituents in a known manner and melt-compounding or melt-extruding them at temperatures of from 200° C. to 300° C. in conventional devices such as internal kneaders, extruders and twin-shaft screws.

Mixing of the individual constituents can, in known manner, be carried out either in succession or simultaneously, both at about 20° C. (room temperature) and at a higher temperature.

Owing to their excellent flame resistance and their high dimensional stability under heat, the thermoplastic molding compositions are suitable for the production of molded articles of any kind. Owing to their dimensional stability under heat and their rheological properties, processing temperatures of over 240° C. are preferred.

The invention relates also to processes for the preparation of the molding compositions and to the use of the molding compositions in the production of molded articles.

The molding compositions maybe processed to molded articles by injection molding, or preferably the molding compositions maybe extruded to sheets or films, particularly preferably to sheets.

The invention relates also to the production of molded articles from previously produced sheets or films by thermoforming.

Thermoforming processes have been described, for example, by G. Burkhardt et al. (“Plastics Processing”, in Ullmann's Encyclopedia of Industrial Chemistry, Wiley-VCH Verlag GmbH & Co. KgaA, 2002) or in Römpp Lexikon Chemie, Georg Thieme Verlag Stuttgart, 1999. Thermoforming processes generally describe processes in which semi-finished plastics products are heated and shaped under the influence of external forces (heat, pressure or vacuum) to form three-dimensional structures.

While drawing (hot forming) involves introducing a preheated plastics sheet between the two parts of the tool, the positive part and the negative part, and then pressing the parts together, as a result of which the plastics part acquires its shape, draw forming is carried out using spring-mounted clamps. The process without a negative tool is referred to as deep-drawing; forming by means of a vacuum (vacuum forming) is also possible.

The extruded flat molded articles described here may be processed, for example, by the deep-drawing process at surface temperatures of from 150° C. to 220° C., particularly preferably at surface temperatures of from 160° C. to 215° C.

Accordingly, the invention also provides a process for the production of the thermoformed molded articles, wherein
(i) in a first step the components of the polycarbonate composition are melted and mixed,
(ii) in a second step the resulting melt is cooled and granulated,
(iii) in a third step the granulate is melted and is extruded into sheets, and
(iv) in a fourth step the sheets are shaped into a three-dimensional article, preferably by means of hot forming, draw forming, deep drawing or vacuum forming under the influence of external forces, for example by means of a one-part or two-part tool and/or by means of vacuum, particular preferably the three-dimensional object is shaped by means of deep drawing, preferably at surface temperatures of the sheets from 150° C. to 220° C., in particularly preferred manner at surface temperatures of the sheets from 160° C. to 215° C.

The molded articles are suitable for the following applications: vehicle parts or interior fittings for passenger vehicles, buses, lorries, motor caravans, rail vehicles, aircraft, ships or other vehicles, cover plates for the construction sector, flat wall elements, partition walls, strips for protecting walls and edges, profiles for electrical installation conduits, cable guides, conductor rail covers, window and door profiles, furniture parts and traffic signs. The molded articles are suitable in particular for the following applications: vehicle parts or interior fittings for passenger vehicles, buses, lorries, motor caravans, rail vehicles and aircraft.

The molded articles are particularly preferably suitable for the production of covers, roof and side cladding, luggage flaps and similar interior cladding for rail vehicles and aircraft.

The Examples which follow serve to illustrate the invention further.

### EXAMPLES

Component A1

Branched polycarbonate based on bisphenol A and having a relative solution viscosity of ηᵣₑₗ=1.34, measured in CH₂Cl₂ as solvent at 25° C. and in a concentration of 0.5 g/100 ml, which has been branched using 0.3 mol. % of isatinbiscresol, based on the sum of bisphenol A and isatinbiscresol.

Component A2

Linear polycarbonate based on bisphenol A and having a relative solution viscosity of ηᵣₑₗ=1.29, measured in CH₂Cl₂ as solvent at 25° C. and in a concentration of 0.5 g/100 ml.

Component A3

Linear polycarbonate based on bisphenol A and having a relative solution viscosity of ηᵣₑₗ=1.28, measured in CH₂Cl₂ as solvent at 25° C. and in a concentration of 0.5 g/100 ml.

Component B1

ABS graft polymer prepared by emulsion polymerization of 43 wt. %, based on the ABS polymer, of a mixture of 27 wt. % acrylonitrile and 73 wt. % styrene in the presence of 57 wt. %, based on the ABS polymer, of a particulate crosslinked polybutadiene rubber (mean particle diameter d₅₀=from 0.3 to 0.4 μm).

Component B2

Impact modifier, methyl-methacrylate-modified silicone acrylate rubber, Metablen® SX 005 from Mitsubishi Rayon Co., Ltd., CAS 143106-82-5.

Component B3

Impact modifier, styrene-acrylonitrile-modified silicone acrylate rubber, Metablen® SRK 200 from Mitsubishi Rayon Co., Ltd., CAS 178462-89-0.

Component C1

Talc, Luzenac® A3C from Luzenac Naintsch Mineralwerke GmbH having a MgO content of 32 wt. %, a SiO₂ content of 61 wt. % and an Al₂O₃ content of 0.3 wt. %.

Component C2

Kaolin (China Clay), Supreme from Imerys Minerals Ltd.

Component C3

Wollastonite, Nyglos® 4W from Nyco having an aspect ratio of 11:1.

Component D

Bisphenol-A-based oligophosphate

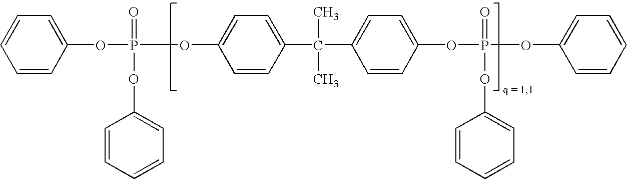

Component E

Polytetrafluoroethylene powder, CFP 6000 N, DuPont.

Component F

Copolymer of 77 wt. % styrene and 23 wt. % acrylonitrile having a weight-average molecular weight M_{w} of 130 kg/mol. (determined by GPC), prepared by the mass process.

Component G

Mixture of 0.2 parts by weight of pentaerythritol tetrastearate as lubricant/mold release agent and 0.1 part by weight of phosphite stabiliser, Irganox® B 900, Ciba Specialty Chemicals.

Preparation and Testing of the Molding Compositions

The substances listed in Table 1 were compounded and granulated in a twin-screw extruder (ZSK-25) (Werner und Pfleiderer) at a speed of 225 rpm and a throughput of 20 kg/h at a machine temperature of 260° C.

The finished granules were processed to the corresponding test specimens on an injection-molding machine (stock temperature 260° C., tool temperature 80° C., flow front speed 240 mm/s). Characterisation was carried out according to DIN EN ISO 180/1A (Izod notched impact strength, sample size 80×10×4 mm³), DIN EN ISO 527 (tensile modulus), DIN ISO 306 (Vicat softening temperature, process B with a load of 50 N and a heating rate of 120 K/h), ISO 11443 (melt viscosity), DIN EN ISO 1133 (melt volume flow rate, MVR) and UL 94 V.

In addition, sheets having a thickness of 3 mm were extruded on a sheet and film installation from Breyer, Singen, at a melt temperature of 270° C. (Breyer 60 degassing extruder without pre-drying of the granules, three-roll smoothing tool, twin-roll take-off, radiometric thickness measurement).

The corresponding test specimen geometries for ASTM E 162 and ASTM E 662 were cut from the extruded sheets. The flame spread index (Is) and the dripping behavior were determined in accordance with ASTM E 162 (with aluminium backing, d=3 mm). The smoke density was determined in accordance with ASTM E 662 (with ignition flame, d=3 mm).

The requirements for materials for American rail vehicles were laid down in the so-called Docket 90 A (Recommended Fire Safety Practices for Transit Bus and Van Materials Selection—published by the Department of Transportation, Federal Transit Administration, Federal Register, Vol. 58, No. 201). According to that document, materials for interior cladding should not exhibit burning drips in ASTM E 162 and must have a flame spread index Is of less than 35; in addition they must have a low smoke density according to ASTM E 662 (Ds 1.5 min<100 and Ds 4 min<200).

The thermoformability may be demonstrated by producing so-called deep-drawn pyramids, the extruded sheets being deep-drawn at 200° C. to a depth of 20 cm to form a stepped pyramid having six elements. The surface quality of the deep-drawn pyramids is assessed visually. The assessment “good” means that no edge cracks and no white fractures occurred at the corners. The assessment “poor” means that either edge cracks and/or white fractures occurred at the corners.

Table 1 shows that only the inventive compositions (Examples 8 to 11 and 18 to 20) meet the requirements according to the American regulations for rail vehicles (Docket 90 A), that is to say exhibit a flame spread index Is of less than 35 according to ASTM E 162, do not exhibit burning drips in the test according to ASTM E 162 and meet the requirements in respect of smoke density according to ASTM E 662 (Ds, 1.5 min<100 and Ds 4 min<200). In addition, the tensile modulus in the case of Examples 8 to 11 and 18 to 20 according to the invention is markedly greater than 3500 N/mm². The comparison examples V1 to V7 and V12 to V17, on the other hand, do not meet at least one of the above-mentioned requirements.

TABLE 1
Composition and properties of the molding compositions

| | | V1 | V2 | V3 | V4 | V5 | V6 | V7 | 8 | 9 | 10 |
|---|---|---|---|---|---|---|---|---|---|---|---|
| Components (wt. %) | | | | | | | | | | | |
| A1 | | 84.5 | 82.6 | 71.6 | 84.5 | 81.6 | 73.6 | 74.5 | 71.6 | 70.6 | 69.6 |
| B1 | | 4.7 | 3.7 | 4.7 | | | | | | | |
| B2 | | | | | 4.7 | 4.7 | 4.7 | 4.7 | 4.7 | 5.7 | 4.7 |
| C1 | | | | 10 | | | 8 | 10 | 10 | 10 | 12 |
| D | | 10.1 | 13 | 13 | 10.1 | 13 | 13 | 10.1 | 13 | 13 | 13 |
| E | | 0.4 | 0.4 | 0.4 | 0.4 | 0.4 | 0.4 | 0.4 | 0.4 | 0.4 | 0.4 |
| G | | 0.3 | 0.3 | 0.3 | 0.3 | 0.3 | 0.3 | 0.3 | 0.3 | 0.3 | 0.3 |
| Properties | | | | | | | | | | | |
| Izod notched impact strength/RT (DIN EN | kJ/m² | 30.3 | 9.8 | 8.6 | 11.2 | 30.8 | 12.4 | 13.8 | 11.0 | 13.8 | 10.1 |
| ISO 180/1A) | | | | | | | | | | | |
| Tensile modulus (DIN EN ISO 527) | N/mm² | 2618 | 2755 | 4055 | 2515 | 2604 | 3612 | 3749 | 3813 | 3806 | 4149 |
| Vicat B 120 (DIN ISO 306) | ° C. | 115 | 108 | 105 | 114 | 105 | 103 | 112 | 103 | 102 | 102 |
| Melt viscosity (260° C.) [100 s⁻¹] | Pas | 1016 | 828 | 856 | 1075 | 866 | 775 | 1161 | 821 | 792 | 734 |
| (ISO 11443) | | | | | | | | | | | |
| Melt viscosity (260° C.) [1000 s⁻¹] | Pas | 399 | 336 | 329 | 408 | 337 | 297 | 406 | 306 | 290 | 281 |
| (ISO 11443) | | | | | | | | | | | |
| Melt viscosity (260° C.) [1500 s⁻¹] | Pas | 313 | 267 | 259 | 317 | 269 | 235 | 315 | 242 | 228 | 224 |
| (ISO 11443) | | | | | | | | | | | |
| MVR 260° C./5 kg (DIN EN ISO 1133) | cm³/ | 11.3 | 15.8 | 12.0 | 10.5 | 12.4 | 14.1 | 7.5 | 13 | 11.5 | 14.5 |
| | 10 min. | | | | | | | | | | |
| UL 94 V (d = 1.5 mm): Classification | s | V0 | V0 | V0 | V0 | V0 | V0 | V0 | V0 | V0 | V0 |
| UL 94 V (d = 1.5 mm): Total after-burning | | 14 | 13 | 11 | 13 | 11 | 10 | 10 | 7 | 10 | 9 |
| time | | | | | | | | | | | |
| Flame spread index Is (ASTM | yes/no | 46 | 24 | 8 | 12 | 26 | 6 | 11 | 5 | 6 | 4 |
| E 162 (d = 3 mm)) | | | | | | | | | | | |
| Burning drips? (ASTM | | yes | yes | yes | yes | yes | yes | yes | no | no | no |
| E 162 (d = 3 mm)) | | | | | | | | | | | |
| Smoke density Ds after 1.5 min (ASTM | | n.d. | n.d. | n.d. | n.d. | 15 | 5 | n.d. | 6 | 7 | 3 |
| E 662 (d = 3 mm)) | | | | | | | | | | | |
| Smoke density Ds after 4 min (ASTM E 662 | | n.d. | n.d. | n.d. | n.d. | 254 | 73 | n.d. | 91 | 74 | 70 |
| (d = 3 mm)) | | | | | | | | | | | |
| Test according to Docket 90 A (d = 3 mm)/ | yes/no | no | no | no | no | no | no | no | yes | yes | yes |
| passed? | | | | | | | | | | | |
| Visual assessment of the deep-drawn | good/ | n.d. | n.d. | n.d. | n.d. | n.d. | n.d. | n.d. | good | good | good |
| pyramids | poor | | | | | | | | | | |
| | | 11 | V12 | V13 | V14 | V15 | V16 | V17 | 18 | 19 | 20 |
| Components (wt. %) | | | | | | | | | | | |
| A1 | | 70.6 | 69.6 | 71.6 | 71.6 | | 35.8 | 50.1 | 71.6 | 70.6 | 69.6 |
| A2 | | | | | | 71.6 | | | | | |
| A3 | | | | | | | 35.8 | 21.5 | | | |
| B2 | | 4.7 | 4.7 | 4.7 | 4.7 | 4.7 | 4.7 | 4.7 | | | |
| B3 | | | | | | | | | 4.7 | 5.7 | 4.7 |
| C1 | | 10 | 10 | | | 10 | 10 | 10 | 10 | 10 | 12 |
| C2 | | | | 10 | | | | | | | |
| C3 | | | | | 10 | | | | | | |
| D | | 13 | 13 | 13 | 13 | 13 | 13 | 13 | 13 | 13 | 13 |
| E | | 0.4 | 0.4 | 0.4 | 0.4 | 0.4 | 0.4 | 0.4 | 0.4 | 0.4 | 0.4 |
| F | | 1 | 2 | | | | | | | | |
| G | | 0.3 | 0.3 | 0.3 | 0.3 | 0.3 | 0.3 | 0.3 | 0.3 | 0.3 | 0.3 |
| Properties | | | | | | | | | | | |
| Izod notched impact strength/RT (DIN EN | kJ/m² | 11.3 | 10.9 | 8.5 | 13.5 | 11.2 | 11 | 11.2 | 10.3 | 10.8 | 7.7 |
| ISO 180/1A) | | | | | | | | | | | |
| Tensile modulus (DIN EN ISO 527) | N/mm² | 3873 | 3889 | 3410 | 3434 | 3737 | 3802 | 3809 | 4148 | 4077 | 4549 |
| Vicat B 120 (DIN ISO 306) | ° C. | 103 | 103 | 102 | 103 | 103 | 103 | 104 | 104 | 103 | 103 |
| Melt viscosity (260° C.) [100 s⁻¹] | Pas | 818 | 751 | 797 | 840 | 587 | 670 | 716 | 790 | 733 | 637 |
| (ISO 11443) | | | | | | | | | | | |
| Melt viscosity (260° C.) [1000 s⁻¹] | Pas | 306 | 253 | 301 | 303 | 279 | 282 | 296 | 305 | 281 | 260 |
| (ISO 11443) | | | | | | | | | | | |
| Melt viscosity (260° C.) [1500 s⁻¹] | Pas | 243 | 182 | 240 | 238 | 224 | 226 | 237 | 242 | 224 | 211 |
| (ISO 11443) | | | | | | | | | | | |
| MVR 260° C./5 kg (DIN EN ISO 1133) | cm³/ | 12.1 | 12.4 | 13.4 | 14.5 | 22.3 | 17.6 | 14.4 | 13.7 | 13.6 | 16.0 |
| | 10 min | | | | | | | | | | |
| UL 94 V (d = 1.5 mm): Classification | s | V0 | V0 | V0 | V0 | V0 | V0 | V0 | V0 | V0 | V0 |
| UL 94 V (d = 1.5 mm): Total after-burning | | 10 | 10 | 3 | 12 | 10 | 6 | 8 | 6 | 3 | 6 |
| time | | | | | | | | | | | |
| Flame spread index Is (ASTM E 162 | yes/no | 11 | 4 | 8 | 10 | 5 | 8 | 5 | 6 | 2 | 1 |
| (d = 3 mm)) | | | | | | | | | | | |
| Burning drips? (ASTM E 162 (d = 3 mm)) | | no | yes | yes | yes | yes | yes | yes | no | no | no |
| Smoke density Ds after 1.5 min (ASTM | | 1 | 1 | 4 | 4 | 1 | 1 | 2 | 3 | 6 | 2 |
| E 662 (d = 3 mm)) | | | | | | | | | | | |
| Smoke density Ds after 4 min (ASTM E 662 | | 59 | 84 | 138 | 253 | 92 | 66 | 87 | 100 | 121 | 156 |
| (d = 3 mm)) | | | | | | | | | | | |
| Test according to Docket 90 A (d = 3 mm)/ | yes/no | yes | no | no | no | no | no | no | yes | yes | yes |
| passed? | | | | | | | | | | | |
| Visual assessment of the deep-drawn | good/ | good | n.d. | n.d. | n.d. | n.d. | n.d. | n.d. | good | good | good |
| pyramids | poor | | | | | | | | | | |

n.d. = not determined

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic composition comprising
A) 40 to 95 parts by weight of at least one member selected from the first group consisting of branched aromatic polycarbonate and branched aromatic polyestercarbonate,
B) 1 to 25 parts by weight of graft polymer containing one or more graft bases selected from the group of the silicone rubber and silicone acrylate rubber,
C) 9 to 18 parts by weight of talc,
D) 11.0 to 20 parts by weight of phosphorus-containing flameproofing agent,
E) 0 to 3 parts by weight of an anti-dripping agent, and
F) 0 to 1.5 parts by weight of at least one member selected from the second group consisting of thermoplastic vinyl (co)polymer and polyalkylene terephthalate.

2. The composition according to claim 1 wherein said member of said first group contains active amine functional groups.

3. The composition according to claim 1 wherein the graft polymer (B) is composed of
B.1) 5 to 95% relative to the weight of the graft polymer of one or more vinyl monomers grafted on
B.2) 95 to 5% relative to the weight of the graft polymer of one or more graft bases selected from the third group consisting of silicone rubber (B.2.1) and silicone acrylate rubber (B.2.2), the graft base having a glass transition temperature of <10° C.

4. The composition according to claim 1 wherein the phosphorus-containing flameproofing agent (D) conforms to formula (VIII) 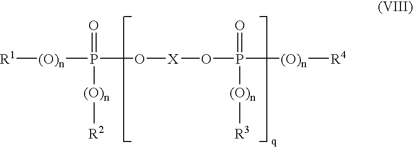
wherein
R¹, R², R³ and R⁴ independently one of the others denote C₁- to C₈-alkyl, C₅- to C₆-cycloalkyl, C₆- to C₂₀-aryl or C₇- to C₁₂-aralkyl,
n independently of one another denote 0 or 1,
q represents 0 to 30, and
X represents a mono- or poly-nuclear aromatic radical having 6 to 30 carbon atoms, or a linear or branched aliphatic radical having 2 to 30 carbon atoms which may be OH-substituted and contain up to 8 ether bonds.

5. The composition according to claim 4, wherein X represents a residue of bisphenol A.

6. The composition according to claim 1 wherein said graft polymer is present in an amount of 4.7 to 6.6 parts by weight.

7. The composition according to claim 1 wherein talc is present in an amount of 10 to 12 parts by weight.

8. The composition according to claim 1 wherein the talc has a mean particle size (d₅₀) of 1.1 to 5 μm.

9. The composition according to claim 1 further containing at least one member selected from the fourth group consisting of lubricant, mold release agent, nucleating agent, antistatic, stabilizer, coloring agent, pigment, filler reinforcing agent and very finely divided inorganic compound having average particle diameter of less than or equal to 200 nm other than talc.

10. The compositions according to claim 9 wherein average particle diameter is less than or equal to 150 nm.

11. A process for the production of thermoformed mold articles comprising in sequence
(i) preparing a molten mixture of the component of the composition of claim 1,
(ii) cooling and granulating said molten blend to obtain a plurality of granules
(iii) extruding said granules to produce a sheet and
(iv) shaping said sheet into a three-dimensional article.

12. The process of claim 11 wherein said shaping is by a process selected from the group consisting of hot forming, draw forming, deep drawing and vacuum forming.

13. The process according to claim 12, wherein the deep drawing is carried out at a surface temperature of the sheet of 150 to 220° C.

14. A molded articles comprising the composition of claim 1.
